(19) United States
(12) Patent Application Publication
(10) Pub. No.: US 2020/0207795 A1
(43) Pub. Date: Jul. 2, 2020

(54) TWO-DIMENSIONAL METAL COMPLEX

(71) Applicant: THE UNIVERSITY OF TOKYO, Tokyo (JP)

(72) Inventors: Hiroshi NISHIHARA, Tokyo (JP); Ryota SAKAMOTO, Tokyo (JP); Kuo-Hui WU, Tokyo (JP); Hiroaki MAEDA, Tokyo (JP); Eunice PHUA, Tokyo (JP); Xinsen SUN, Tokyo (JP); Jian CAO, Tokyo (JP)

(21) Appl. No.: 16/314,011

(22) PCT Filed: Jun. 28, 2017
(86) PCT No.: PCT/JP2017/023732

§ 371 Date: Jul. 23, 2019

(30) Foreign Application Priority Data
Jun. 29, 2016 (JP) 2016-129293

(51) Int. Cl. C07F 15/04; C25B 11/04; H01G 11/02; H01G 11/48; H01G 11/86

(52) U.S. Cl. CPC C07F 15/045; C25B 11/0447; H01G 11/86; H01G 11/48; H01G 11/02

(57) ABSTRACT

The present invention provides a substance and/or a material, which is inexpensive compared to platinum, has a hydrogen-generating catalyst capability, has the desired oxidation-reduction properties, and is provided with multiple holes. The present invention provides a two-dimensional metal complex comprising a metal core M (M is at least one metal selected from the group consisting of Ni, Co, Cu, Pt, Pd, Fe, Mn, Re, Ru, Os, Rh, Ir, Ag, and Au), and a ligand having three or more positions for coordination through two sites, at least one site among the two sites being NH. Substantially all of the atoms of the ligand and the metal core substantially forming the metal complex are present approximately on the same plane.

### TECHNICAL FIELD

The present invention relates to a two-dimensional metal complex. In particular, the present invention relates to a two-dimensional metal complex with a ligand having three or more positions for bidentate coordination, in which at least one of the bidentate coordination sites is NH and substantially all of the atoms of the ligand and the metal core, which substantially form the metal complex, are present on substantially the same plane.

Further, the present invention relates to a material comprising the two-dimensional metal complex.

More, the present invention relates to an element and/or a device comprising the two-dimensional metal complex and/or the material described above.

Further, the present invention relates to a manufacturing method for the two-dimensional metal complex.

### BACKGROUND ART

Hydrogen has been expected as a clean energy source, and development of an efficient manufacturing method for hydrogen is a technology that leads to the foundation of the clean energy. One known example of the excellent hydrogen generating electrode is platinum; however, since platinum is expensive, another electrode material has been demanded.

A capacitor that has high capacity and that can be charged and discharged quickly has been required recently, and a lithium ion capacitor, an electric double-layer capacitor, and the like have been developed. In particular, development of a capacitor with both characteristics of high output density and high energy density has been demanded.

### DISCLOSURE OF THE INVENTION

### Problems to be Solved by the Invention

An object of the present invention is to provide a substance and/or a material that is less expensive than platinum, that has a catalytic ability to generate hydrogen and a desired redox characteristic, and that includes a number of pores.

Further, an object of the present invention is, other than or in addition to the above object, to provide a substance and/or a material that can be used as a capacitor, in particular, a redox capacitor, with both characteristics of high output density and high energy density.

More, an object of the present invention is, other than or in addition to the above objects, to provide an element and/or a device comprising the substance and/or the material.

Further, an object of the present invention is, other than or in addition to the above objects, to provide a manufacturing method for the substance and/or the material.

### Means for Solving Problems

The present inventors have found following inventions:

<1> A two-dimensional metal complex comprising:

a ligand having three or more positions for bidentate coordination, in which at least one of the bidentate coordination sites is NH; and

a metal core M, wherein M is at least one metal selected from the group consisting of Ni, Co, Cu, Pt, Pd, Fe, Mn, Re, Ru, Os, Rh, Ir, Ag, and Au;

wherein substantially all of the atoms of the ligand and the metal core, which substantially form the metal complex, are present on substantially the same plane.

<2> In the above item <1>, the ligand may comprise an aryl group.

<3> In the above item <1> or <2>, the ligand may be represented by Ar(NH)ₙXₘ₋ₙ, wherein Ar represents an aryl group, X is at least one selected from the group consisting of S, O, Se and Te, m represents an integer of 6 or more, which is the number of bonding sites depending on the aryl group, and n represents an integer of 3 or more and m or less.

<4> In anyone of the above items <1> to <3>, the ligand may be represented by Bz (NH)ₙX₆₋ₙ wherein Bz represents a benzene ring, X is at least one selected from the group consisting of S, O, Se, and Te, and n represents an integer of 3 to 6. the ligand may be preferably represented by following formula L-1 or L-2:

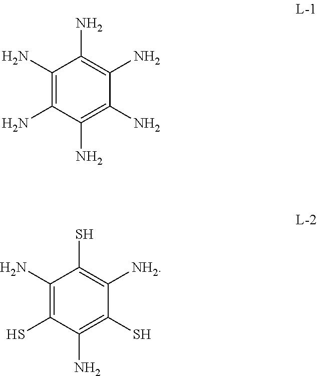 [SMILES: Nc1c(N)c(N)c(N)c(N)c1N ; Nc1c(S)c(N)c(S)c(N)c1S]

<5> In anyone of the above items <1> to <4>, the two-dimensional metal complex may comprise four or more ligands, preferably six or more ligands, more preferably ten or more ligands, most preferably thirteen or more ligands.

<6> In anyone of the above items <1> to <5>, the two-dimensional metal complex may comprise three or more metal cores, preferably six or more metal cores, more preferably eleven or more metal cores, most preferably fifteen or more metal cores.

<7> In anyone of the above items <1> to <6>, the two-dimensional metal complex may comprise a site represented by following formula C-1, wherein each of M₁ to M₆ is independently at least one selected from the group consisting of Ni, Co, Cu, Pt, Pd, Fe, Mn, Re, Ru, Os, Rh, Ir, Ag, and Au, and each of Xₙ₁ to Xₙ₆ (n is 1 to 6) is independently a ligand atom or a ligand atom group represented by NH, S, O, Se, or Te:

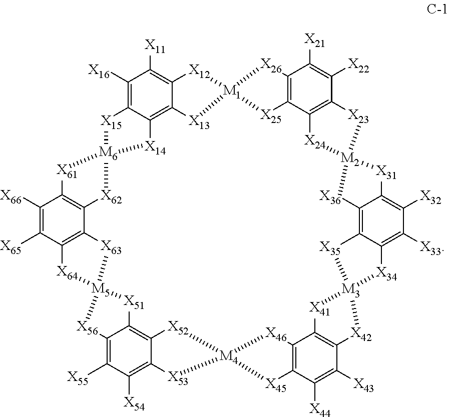

<8> A two-dimensional metal complex comprising a site represented by the above formula C-1, wherein M₁ to M₆ and Xₙ₁ to Xₙ₆ (n is 1 to 6) have the same definitions as described above.

<9> In anyone of the above items <1> to <8>, an area of the plane formed by substantially all of the atoms of the ligand and the metal core, which substantially form the two-dimensional metal complex, may be 7.2 nm² or more, preferably 13.2 nm² or more, more preferably 18.6 nm² or more.

<10> In anyone of the above items <1> to <9>, the two-dimensional metal complex may have a conductivity of 10⁻⁶ Scm⁻¹ or more, preferably 10⁻³ Scm⁻¹ or more, 10⁻¹ Scm⁻¹ or more.

<11> In anyone of the above items <1> to <10>, the two-dimensional metal complex may have a redox potential in a range of −3 V to +3 V vs. SHE (standard hydrogen electrode), preferably −2 V to +2 V vs. SHE, more preferably −1 V to +2 V vs. SHE.

<12> In anyone of the above items <1> to <11>, the two-dimensional metal complex may have a porosity of 30% or more, preferably 33% or more, more preferably 35% or more. Furthermore, the term “porosity” used herein represents a ratio of pores in the area of the substantially same plane.

<13> A material comprising the two-dimensional metal complex according to any one of the above items <1> to <12>.

<14> An element or a device comprising the material according to the above item <13>.

<15> An element or a device comprising the two-dimensional metal complex according to any one of the above items <1> to <12>.

<16> A method for manufacturing the two-dimensional metal complex according to any one of the above items <1> to <12>, preferably the two-dimensional metal complex according to any one of the above items <2> to <12>, more preferably the two-dimensional metal complex according to anyone of the above items <3> to <12>, most preferably the two-dimensional metal complex according to any one of the above items <4> to <12>, comprising the steps of:

a) preparing a ligand;

b) preparing a compound of a metal M, which is a raw material of a metal core M;

c) dissolving the ligand that is prepared in the step a) and the compound of the metal M that is prepared in the step b) in a solvent in which the ligand and the compound are soluble in an oxygen-free environment, to obtain a solution; and

d) bringing the solution that is obtained in the step c) in contact with gas including oxygen, thereby to form the two-dimensional metal complex at an interface of the solution.

<17> A method for manufacturing the two-dimensional metal complex according to any one of the above items <1> to <12>, preferably the two-dimensional metal complex according to any one of the above items <2> to <12>, more preferably the two-dimensional metal complex according to any one of the above items <3> to <12>, most preferably the two-dimensional metal complex according to any one of the above items <4> to <12>, comprising the steps of:

a) preparing a ligand;

b) preparing a compound of a metal M, which is a raw material of a metal core M;

c) dissolving the ligand that is prepared in the step a) and the compound of the metal M that is prepared in the step b) in a solvent in which the ligand and the compound are soluble in an oxygen-free environment, to obtain a solution; and

e) providing a positive electrode and a negative electrode in the solution that is obtained in the step c) and applying current between the positive electrode and the negative electrode, thereby to form the two-dimensional metal complex on a surface of the positive electrode.

<18> In the above item <17>, the current may be applied at a constant potential that is more positive than an oxidizing potential of the ligand in a range of −3 to 3 V vs. SHE, preferably in a range of −2 to 2 V vs. SHE, more preferably in a range of −1 to 2 V vs. SHE, specifically more positive than the oxidizing potential by 60 mV, preferably 120 mV.

<19> In the above item <17> or <18>, the anode may be an electrode with high conductivity and a wide potential window, for example, the anode may have a conductivity of 1 Scm⁻¹ or more and a potential window of −2 to 1 V vs. SHE. Specifically, the anode may be, but is not limited to, glassy carbon, graphite, ITO (IndiumTinOxide) glass, platinum, gold, conductive diamond, or the like. In a case of manufacturing an electrode catalyst or a modified electrode for a redox capacitor, it is desirable that the specific surface area is large; a material with a specific surface area of preferably 50 m²/g, more preferably 200 m²/g, may be used. The material may be, but not limited to, porous carbon.

<20> An electrode comprising the two-dimensional metal complex obtained by the method described in any one of the above items <17> to <19>,

<21> A method for manufacturing the two-dimensional metal complex according to any one of the above items <1> to <12>, preferably the two-dimensional metal complex according to any one of the above items <2> to <12>, more preferably the two-dimensional metal complex according to any one of the above items <3> to <12>, most preferably the two-dimensional metal complex according to any one of the above items <4> to <12>, comprising the steps of:

a) preparing a ligand;

b) preparing a compound of a metal M, which is a raw material of a metal core M;

c′)-1) dissolving the ligand that is prepared in the step a) in a first solvent in which the ligand is soluble, to obtain a solution C-1;

c′)-2) dissolving the compound of the metal M that is prepared in the step b) in a second solvent in which the compound is soluble to obtain a solution C-2;

f) dissolving an oxidant in the solution C-1 and/or the solution C-2; and

g) pouring the obtained solution C-1 and the obtained solution C-2 into a container so that the solutions are separated into two phases, thereby to form the two-dimensional metal complex at an interface of the two phases.

<22> A solution for manufacturing the two-dimensional metal complex according to any one of the above items <1> to <12>, preferably the two-dimensional metal complex according to any one of the above items <2> to <12>, more preferably the two-dimensional metal complex according to any one of the above items <3> to <12>, most preferably the two-dimensional metal complex according to any one of the above items <4> to <12>, comprising:

i) a ligand;

ii) a compound of a metal M, which is a raw material of a metal core M; and

iii) a solvent in which i) the ligand and ii) the compound are soluble,

wherein i) the ligand and ii) the compound are dissolved in the solution and the solution can be present in an oxygen-free environment.

<23> A solution kit for manufacturing the two-dimensional metal complex according to anyone of the above items <1> to <12>, preferably the two-dimensional metal complex according to anyone of the above items <2> to <12>, more preferably the two-dimensional metal complex according to any one of the above items <3> to <12>, most preferably the two-dimensional metal complex according to any one of the above items <4> to <12>, comprising:

I) a first solution including A) a ligand and B) a first solvent that dissolves A) the ligand, wherein the I) first solution dissolves A) the ligand, and is present in an oxygen-free environment; and

II) a second solution including C) a compound of a metal M, which is a raw material of a metal core M, and D) a second solvent that dissolves C) the compound, wherein the II) second solution dissolves C) the compound, and is present in the oxygen-free environment.

### Effects of the Invention

The present invention can provide a substance and/or a material that is less expensive than platinum, that has a catalytic ability to generate hydrogen and a desired redox characteristic, and that includes a number of pores.

Further, other than or in addition to the above effect, the present invention can provide a substance and/or a material that can be used as a capacitor, in particular, a redox capacitor, with both characteristics of high output density and high energy density.

More, other than or in addition to the above effects, the present invention can provide an element and/or a device comprising the substance and/or the material.

Further, other than or in addition to the above effects, the present invention can provide a manufacturing method for the substance and/or the material.

### BRIEF DESCRIPTION OF DRAWINGS

FIG. 1 shows a catalytic ability to generate hydrogen in 0.05 M H₂SO₄ (pH=1) at an electrode comprising a sheet substance B1 that is obtained in Example 2 (in FIG. 1, expressed as “Ni-CONASH”), and an electrode comprising a sheet substance B3 that is obtained in Example 3 (in FIG. 1, expressed as “Co-CONASH”). The horizontal axis represents voltage (V vs. RHE) and the vertical axis represents current density (mA/cm²). Furthermore, FIG. 1 also shows a catalytic ability to generate hydrogen at a glassy carbon electrode (in FIG. 1, expressed as “GC-electrode”) and platinum (in FIG. 1, expressed as “Pt”).

FIG. 2 shows a catalytic ability to generate hydrogen in 1 M KCl (pH=7) of the electrode comprising a sheet substance B1 that is obtained in Example 2 (in FIG. 2, expressed as “Ni-CONASH”), and the electrode comprising a sheet substance B3 that is obtained in Example 3 (in FIG. 2, expressed as “Co-CONASH”). The horizontal axis and the vertical axis are defined the same as those in FIG. 1.

FIG. 3 shows a catalytic ability to generate hydrogen in 0.1 M KOH (pH=13) of the electrode comprising a sheet substance B1 that is obtained in Example 2 (in FIG. 3, expressed as “Ni-CONASH”), and the electrode comprising a sheet substance B3 that is obtained in Example 3 (in FIG. 3, expressed as “Co-CONASH”). The horizontal axis and the vertical axis are defined the same as those in FIG. 1 and FIG. 2.

FIG. 4 indicates the electrode comprising a sheet substance B1 that is obtained in Example 2 exhibits a catalytic ability to generate oxygen. The horizontal axis represents overpotential (V vs. RHE), and the vertical axis represents current density (mA/cm²).

FIG. 5 shows results of cyclic voltammetry of an electrode comprising a sheet substance B1 that is obtained in Example 2 (in FIG. 5, expressed as “HAB-Ni Sheets”), and an electrode without the sheet substance B1 (in FIG. 5, expressed as “Supporting electrode”). The horizontal axis represents a potential (V vs. Li⁺/Li) and the vertical axis represents current (×10⁻³ A).

FIG. 6 shows a catalytic ability to generate hydrogen in 0.05 MH₂SO₄ (pH=1) at an electrode comprising a sheet substance C2 that is obtained in Example 6 (in FIG. 6, expressed as “N1/GC”). The horizontal axis represents voltage (V vs. RHE) and the vertical axis represents current density (μA/cm²). Furthermore, FIG. 6 also shows a catalytic ability to generate hydrogen at a glassy carbon electrode (in FIG. 6, referred to as “GC”) and platinum (in FIG. 6, referred to as “Pt”).

### EMBODIMENTS FOR CARRYING OUT THE INVENTION

The present invention will be described in detail hereinafter.

The present application discloses a two-dimensional metal complex. Specifically, the present invention discloses a two-dimensional metal complex comprising: a ligand having three or more positions for bidentate coordination, in which at least one of the bidentate coordination sites is NH; and a metal core M (M is at least one metal selected from the group consisting of Ni, Co, Cu, Pt, Pd, Fe, Mn, Re, Ru, Os, Rh, Ir, Ag, and Au) wherein substantially all of the atoms of the ligand and the metal core, which substantially form the metal complex, are present on substantially the same plane.

Further, the present application discloses a material comprising the two-dimensional metal complex.

More, the present application discloses an element and/or a device comprising the two-dimensional metal complex and/or the material.

Further, the present invention discloses a manufacturing method for the two-dimensional metal complex.

Hereinafter, a two-dimensional metal complex, a material comprising the complex, an element or the device comprising the complex or the material comprising the complex, and a manufacturing method for the complex will be described in this order.

### <Two-Dimensional Metal Complex>

The present application discloses a two-dimensional metal complex.

The two-dimensional metal complex comprises: a ligand having three or more positions for bidentate coordination, in which at least one of the bidentate coordination sites is NH; and a metal core M (M is at least one metal selected from the group consisting of Ni, Co, Cu, Pt, Pd, Fe, Mn, Re, Ru, Os, Rh, Ir, Ag, and Au) wherein substantially all of the atoms of the ligand and the metal core, which substantially form the metal complex, are present on substantially the same plane.

Here, in the sentences “substantially all of the atoms of the ligand and the metal core, which substantially form the metal complex, are present on substantially the same plane”, “substantially all of the atoms of the ligand, which substantially form the metal complex” intends to exclude the atoms that do not contribute as a ligand to formation of the metal complex.

In addition, “present on substantially the same plane” means that all of the atoms that contribute to the formation of the metal complex are present within a width of 10 nm as a plane, preferably within 1 nm.

### <Ligand>

In the present application, the ligand has three or more positions for bidentate coordination, in which at least one of the bidentate coordination sites is NH. Here, “bidentate coordination” means that, in the same ligand, two bonds are coordinated to the same metal core. In addition, “having three or more positions for bidentate coordination” means that the same ligand comprises three sets of bidentate coordination.

The ligand may comprise an aryl group. Examples of the aryl group may include, but are not limited to, the following groups.

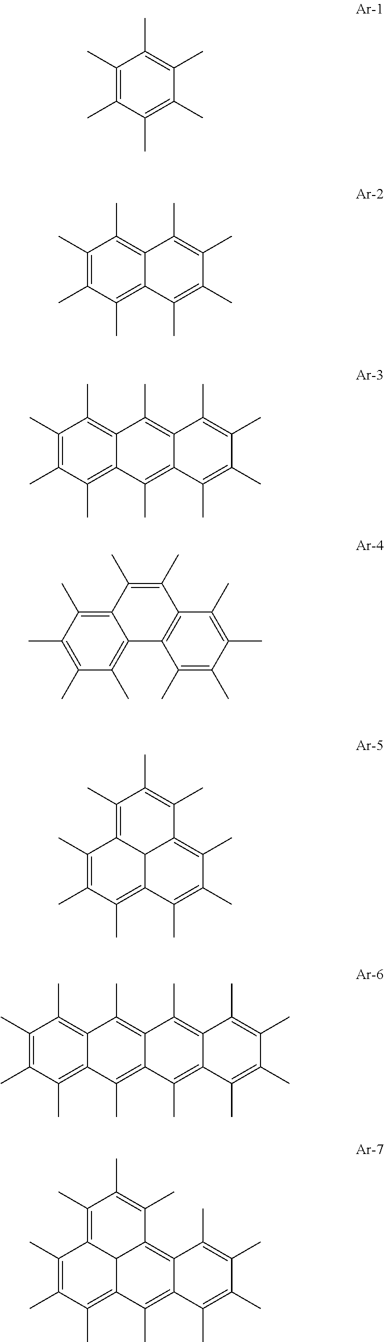

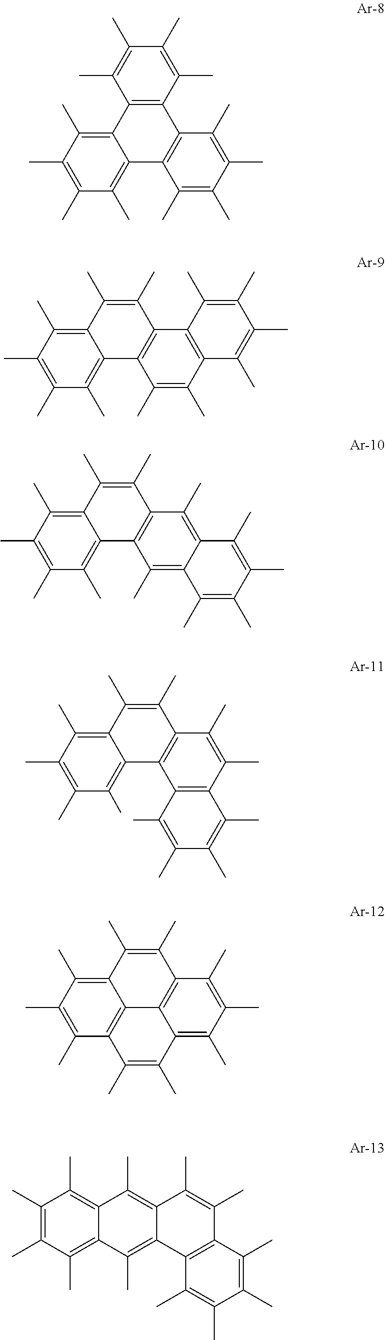

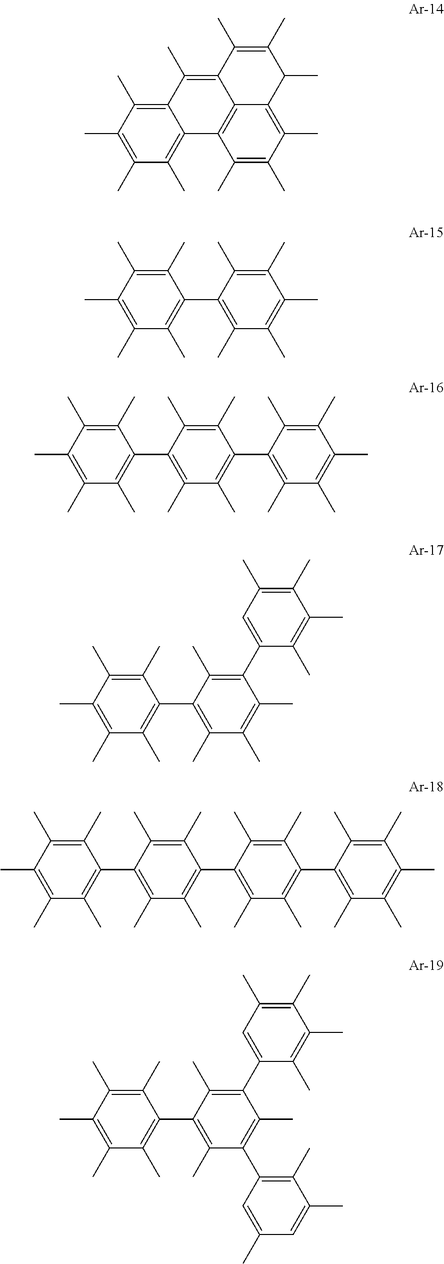

The ligand in the present invention may be a compound represented by Ar(NH)ₙXₘ₋ₙ.

Here, Ar represents an aryl group. Ar may include, but is not limited to, for example, one or more selected from the group consisting of Ar-1 to Ar-19 shown above.

X may be at least one selected from the group consisting of S, O, Se, and Te, preferably S or O, more preferably S.

“m” represents an integer of 6 or more and the number of bonding sites depending on the aryl group. For example, in a case where Ar is Ar-11, there are 12 bonding sites; therefore, m is 12 at maximum.

In addition, n is an integer of 3 or more and m or less.

In particular, the ligand according to the present invention may be a compound represented by Bz (NH)ₙX₆₋ₙ, wherein Bz represents a benzene ring, and X and n have the same definitions as described above. Furthermore, n may be preferably 3 or 6, more preferably 6. The ligand according to the present invention may be preferably a compound represented by following formulas L-1 or L-2, more preferably formula L-1.

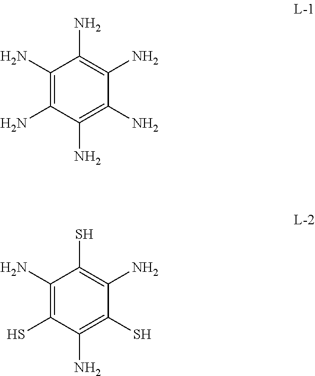 [SMILES: Nc1c(N)c(N)c(N)c(N)c1N ; Nc1c(S)c(N)c(S)c(N)c1S]

The ligand may include a ligand other than the above ligand in the two-dimensional metal complex according to the present invention. Examples of the ligand other than the above ligand may include, but are not limited to, a compound having four —NH₂ in a benzene ring, i.e., a compound represented by following formulas LC-1 or LC-2, and a compound having two —NH₂ in a benzene ring, i.e., a compound represented by following formula LC-3. Furthermore, in a case where the compound represented by any of following formulas LC-1 to LC-3 is used as a ligand, the compound has an action of reducing the spread of the plane of the two-dimensional metal complex. Therefore, in order to promote the spread of the plane of the two-dimensional metal complex, it is preferable that an amount of the ligand may be less.

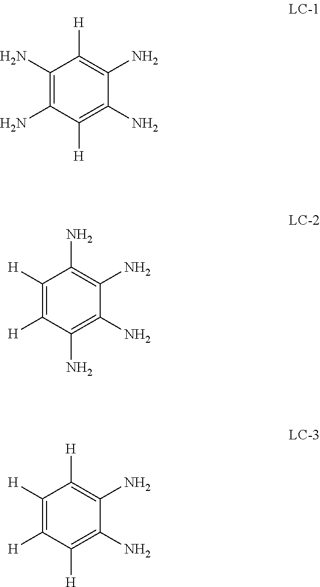 [SMILES: Nc1cc(N)c(N)cc1N ; Nc1ccc(N)c(N)c1N ; Nc1ccccc1N]

In the two-dimensional metal complex according to the present invention, the number of ligands, which depends on the spread of the plane of the two-dimensional metal complex, may be 4 or more, preferably 6 or more, more preferably 10 or more, further more preferably 13 or more.

### <Metal Core>

In the metal core M in the two-dimensional metal complex according to the present invention, M may be a metal having a structure of aplanar coordination as the coordination structure. For example, as described above, the metal core M may be at least one metal selected from the group consisting of Ni, Co, Cu, Pt, Pd, Fe, Mn, Re, Ru, Os, Rh, Ir, Ag, and Au.

The preferable metal core M, depending on the characteristics of the two-dimensional metal complex to be obtained, such as the conductivity or the redox potential, may be preferably at least one selected from the group consisting of Ni, Co, Cu, Fe, and Mn, more preferably at least one selected from the group consisting of Ni, Co, and Cu.

In the two-dimensional metal complex according to the present invention, the number of metal cores, depending on the spread of the plane of the two-dimensional metal complex, may be 3 or more, preferably 6 or more, more preferably 11 or more, further more preferably 15 or more.

### <Structure of Two-Dimensional Metal Complex>

As described above, the two-dimensional metal complex according to the present invention comprises: a ligand having three or more positions for bidentate coordination, in which at least one of the bidentate coordination sites is NH; and a metal core M (M is at least one selected from the group consisting of Ni, Co, Cu, Pt, Pd, Fe, Mn, Re, Ru, Os, Rh, Ir, Ag, and Au) wherein substantially all of the atoms of the ligand and the metal core, which substantially form the metal complex, are present on substantially the same plane.

A structure thereof may comprise, depending on the ligand to be used, in particular, the number of coordinate bonding sites in the ligand, a site represented by following formula C-1, for example, in a case where a compound represented by Bz (NH)ₙX₆₋ₙ such as a compound represented by the above formula L-1 or L-2, is used as the ligand.

In the formula C-1, each of M₁ to M₆ is independently at least one selected from the group consisting of Ni, Co, Cu, Pt, Pd, Fe, Mn, Re, Ru, Os, Rh, Ir, Ag, and Au.

Each of Xₙ₁ to Xₙ₆ (n is 1 to 6) is independently a ligand atom represented by NH, S, O, Se, or Te, or a ligand atom group.

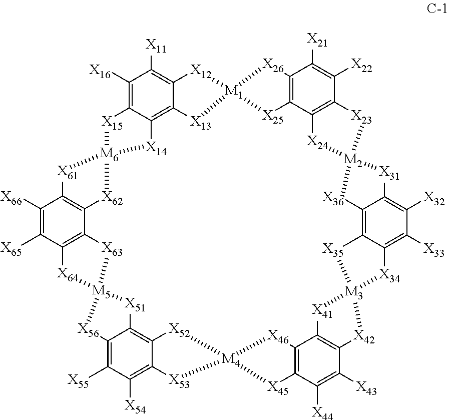

### <<Characteristics of Two-Dimensional Metal Complex>>

The two-dimensional metal complex according to the present application may have one, two, three, or more of the following characteristics i) to iv).

i) In the two-dimensional metal complex, a plane formed with substantially all of the atoms of the ligand and the metal core, which substantially form the metal complex, may have an area of 7.2 nm² or more, preferably 13.2 nm² or more, more preferably 18.6 nm² or more. The area can be obtained from the structure of the ligand that is used in the two-dimensional metal complex and the atomic radii of the atoms of the ligand and the metal cores that substantially form the complex.

ii) The conductivity may be 10⁻⁶ Scm⁻¹ or more, preferably 10⁻³ Scm⁻¹ or more, more preferably 10⁻¹ Scm⁻¹ or more. Furthermore, the conductivity can be determined by a conductivity measurement method such as a two-terminal sensing method or a four-terminal sensing method such as van der Pauw method.

iii) The redox potential may be −3 V to +3 V vs. SHE (standard hydrogen electrode), and preferably in the range of −2 V to +2 V vs. SHE, more preferably in the range of −1 V to +2 V vs. SHE. Furthermore, the redox potential can be determined by electrochemical measurement such as a cyclic voltammetry.

iv) The two-dimensional metal complex may have a porosity of 30% or more, preferably 33% or more, more preferably 35% or more. In the present application, “porosity” refers to the ratio of pores to the area of the substantially same plane. Therefore, similar to the i) area, the porosity can be obtained from the structure of the ligand that is used in the two-dimensional metal complex and the atomic radius of the atom and the metal core of the ligand that substantially forms the complex.

### <Material of Two-Dimensional Metal Complex>

The present application discloses a material comprising the two-dimensional metal complex.

Examples of the material comprising the two-dimensional metal complex may include, but are not limited to, a material comprising the two-dimensional metal complex on a predetermined substrate, and a free standing film consisting of the two-dimensional metal complex, and the like.

Specific examples of the material comprising the two-dimensional metal complex on the predetermined substrate may include, but are not limited to, a two-dimensional metal complex formed on the electrode obtained by electrochemical preparation to be described below.

### <Element or Device Comprising the Two-Dimensional Metal Complex> and <Element or Device Comprising the Material Comprising Two-Dimensional Metal Complex>

The present application discloses an element or a device comprising the two-dimensional metal complex, and an element or a device comprising the material comprising the two-dimensional metal complex.

Such an element or a device may be, but not limited to, a diode, a transistor, a phototransistor, a resonator, an element or a device with a thermoelectric characteristic, an element or a device with a piezoelectric characteristic, alight-emitting element, valleytronics, a battery, a capacitor (including electric double-layer capacitor and redox capacitor), an optical catalyst, a hydrogen generating catalyst, an oxygen generating catalyst, a carbon dioxide reducing catalyst, or the like.

For example, in a case where the two-dimensional metal complex according to the present application is used as a redox capacitor, the following structure may be employed. That is, the redox capacitor may be, but is not limited to, one consisting of the two-dimensional metal complex, one using the two-dimensional metal complex according to the present application as a polymer solid electrolyte film, or one using the two-dimensional metal complex disposed between two electrode substrates.

<Method for manufacturing the two-dimensional metal complex>

The present application discloses a method for manufacturing the two-dimensional metal complex.

The method for manufacturing the two-dimensional metal complex according to the present invention comprises a reaction between the ligand and a compound of the metal M, which is a raw material of the metal core M, under an oxidizing condition, and the method is classified into following three methods:

i) a method comprising a reaction at a gas-liquid interface; ii) an electrochemical method; and iii) a method comprising a reaction at a liquid-liquid interface.

The methods will be described in order.

### <<Manufacturing Method for Two-Dimensional Metal Complex—Comprising Reaction at Gas-Liquid Interface>>

The two-dimensional metal complex can be obtained by a method comprising the reaction at the gas-liquid interface.

This method comprises the steps of:

a) preparing a ligand;

b) preparing a compound of a metal M, which is a raw material of a metal core M;

c) dissolving, in an oxygen-free environment, the ligand that is prepared in the step a) and the compound of the metal M that is prepared in the step b) in a solvent in which the ligand and the compound are soluble, to obtain a solution; and

d) bringing the solution obtained in the step c) in contact with gas including oxygen. Thus, the two-dimensional metal complex can be formed at an interface of the solution.

In the present method, “ligand”, “metal core M”, and “compound of metal M” have the same definitions as described above.

The step a) is the step of preparing the ligand. The ligand may be, if commercially available, purchased, or manufactured newly.

The step b) is the step of preparing the compound of the metal M, which is the raw material of the metal core M of the two-dimensional metal complex.

Here, the compound may be, but is not limited to, depending on the reactivity with the ligand to be used or the solvent or metal to be used in the reaction, acetate, chloride, sulfate, tetrafluoroborate, hexafluorophosphate, perchlorate, acetylacetonato complex, ammine complex, or the like. Furthermore, the compound is selected in consideration of the relation with the solvent or the ligand to be used in the step c), and moreover selected based on the condition in which, for example, how easily the compound is dissolved in the solvent, the compound is not decomposed by light or the like, and if the compound is a complex, the bond between the metal and the ligand is not strong and the ligand substitution reaction easily occurs.

Taking the above things into consideration, the compound may be present stably in solution, and preferably, the ligand substitution reaction easily occurs.

The step c) is the step of dissolving the ligand that is prepared in the step a) and the compound of the metal M that is prepared in the step b) in the solvent in which the ligand and the compound are soluble, to obtain a solution.

The solution may contain an additive that accelerates the reaction in the step d), such as ammonia or amines.

The step c) may be performed under an oxygen-free condition, such as an argon atmosphere or a nitrogen atmosphere. Furthermore, the steps a) and/or the step b) may also be performed under an oxygen-free condition, such as an argon atmosphere or a nitrogen atmosphere.

The step d) is the step of bringing the solution obtained in the step c) in contact with gas including oxygen.

The step d) may be performed under the condition, depending on the ligand to be used, the concentration thereof, the compound of the metal M, the concentration thereof, the amount of oxygen to be used, and the like, such as a room temperature of 25° C. or its vicinity, a pressure of 1 atm, or the like.

The above steps can obtain the two-dimensional metal complex.

Step (s) other than the above steps may be provided, before the step a), between the steps, and/or after the step d).

For example, the step d) may be followed by a step of cleaning the obtained two-dimensional metal complex.

In the step c), a step of varying the concentration of oxygen may be provided.

### <<Manufacturing Method for Two-Dimensional Metal Complex—by Electrochemical Method>>

The above two-dimensional metal complex can be obtained by an electrochemical method.

This method comprises the steps of:

a) preparing a ligand;

b) preparing a compound of a metal M, which is a raw material of a metal core M;

c) dissolving, in the oxygen-free environment, the ligand that is prepared in the step a) and the compound of the metal M that is prepared in the step b) in a solvent in which the ligand and the compound are soluble, obtain a solution; and

e) providing an anode and a cathode in the solution that is obtained in the step c) and applying current between the positive electrode and the cathode; thereby to form the two-dimensional metal complex on a surface of the positive electrode.

In the present method, “ligand”, “metal core M”, and “compound of metal M” have the same definitions as described above.

The steps a) to c) are the steps having the same definitions as described above.

In the present method, the compound of the metal M may be present stably in solution, and preferably, the ligand substitution reaction easily occurs.

Further, in the present method, the ligand may be present stably in solution, and the coordinating ability of the ligand to metal may be increased by oxidation.

The step c) may be performed under the oxygen-free condition, such as an argon atmosphere or a nitrogen atmosphere, as described above. The step a) and/or the step b) may also be performed under the oxygen-free condition, such as an argon atmosphere or a nitrogen atmosphere.

The solution that is obtained in the step c) may comprise the additive that accelerates the reaction in the step e), such as ammonia or amines.

The step e) is the step of providing the anode and the cathode in the solution that is obtained in the step c) and applying current between the anode and the cathode.

The current may be applied by a constant-current method in which constant current is applied, a constant-potential method in which a constant potential is applied, or a potential sweeping method. The current is applied preferably at the constant potential that is more positive than the oxidizing potential of the ligand and may be in the range of −3 to 3 V vs. SHE, preferably −2 to 2 V vs. SHE, more preferably −1 to 2 V vs. SHE, specifically more positive than the oxidizing potential by 60 mV, preferably 120 mV.

The anode may be an electrode with high conductivity and a wide potential window. For example, a material with a conductivity of 1 Scm⁻¹ or more and a potential window of −2 to 1 V vs. SHE is preferable. Specifically, the anode may be formed of glassy carbon, graphite, (ITO (Indium Tin Oxide)), glass, platinum, gold, conductive diamond, or the like; however, the material is not limited to these examples. In a case of manufacturing an electrode catalyst or a modified electrode for a redox capacitor, it is desirable that the specific surface area is large; a material with a specific surface area of preferably 50 m²/g, more preferably 200 m²/g, may be used. The material may be, but not limited to, porous carbon.

In the present method, similar to the method comprising the reaction at the gas-liquid interface, a step(s) other than the aforementioned steps may be provided before the step a), between the steps, and/or after the step e).

For example, the step e) may be followed by a step of cleaning the obtained two-dimensional metal complex.

Since the two-dimensional metal complex can be formed on the electrode, the two-dimensional metal complex formed on the electrode can be used directly as the material comprising the two-dimensional metal complex, the element or the device comprising the two-dimensional metal complex, or the element or the device comprising the material comprising the two-dimensional metal complex.

### <<Manufacturing Method for Two-Dimensional Metal Complex—Comprising Reaction at Liquid-Liquid Interface>>

The two-dimensional metal complex can be obtained by a method comprising a reaction at the liquid-liquid interface.

This method comprises the steps of:

a) preparing a ligand;

b) preparing a compound of a metal M, which is a raw material of a metal core M;

c′)-1) dissolving the ligand that is prepared in the step a) in a first solvent in which the ligand is soluble, to obtain a solution C-1;

c′)-2) dissolving the compound of the metal M that is prepared in the step b) in a second solvent in which the compound is soluble, to obtain a solution C-2;

f) dissolving an oxidant in the solution C-1 and/or the solution C-2; and

g) pouring the solution C-1 and the solution C-2 into a container so that the solutions are separated into two phases;

thereby to form the two-dimensional metal complex at the interface of the two phases.

The steps a) and b) are defined as described above.

In the present method, the compound of the metal M may be present stably in solution, and preferably, the ligand substitution reaction easily occurs.

Further, in the present method, the ligand may be present stably in solution, and the coordinating ability of the ligand to metal may be increased by oxidation.

The step c′)-1) is the step of dissolving the ligand that is prepared in the step a) in the first solvent in which the ligand is soluble, to obtain the solution C-1.

The step c′)-2) is the step of dissolving the compound of the metal M that is prepared in the step b) in the second solvent in which the compound is soluble, to obtain the solution C-2.

A concentration of the ligand in the solution C-1 may be, depending on the ligand to be used, the compound of the metal M to be used, or the like, adjusted in accordance with the thickness of the intended two-dimensional metal complex film. In order to obtain a multilayer film, the concentration may be 0.1 to 2 mM, preferably 0.2 to 1 mM, more preferably 0.3 to 0.7 mM. In order to obtain several ultrathin films from a single layer, the concentration may be 0.005 to 0.2 mM, preferably 0.01 to 0.15 mM, more preferably 0.05 to 0.1 mM.

The concentration of the compound of the metal M in the solution C-2 may be, depending on the ligand to be used, the compound of the metal M to be used, or the like, adjusted in accordance with the thickness of the intended two-dimensional metal complex film. The concentration may be 10 nM to 200 μM, preferably 20 nM to 100 μM, more preferably 50 nM to 50 μM.

The first solvent is a solvent that dissolves the ligand, and the second solvent is a solvent that dissolves the compound of the metal M. The first solvent and the second solvent may be the solvents that are separated into two phases as described below.

The steps c)-1) and c)-2) may be performed under the oxygen-free condition, such as an argon atmosphere or a nitrogen atmosphere. The step a) and/or the step b) may also be performed under the oxygen-free condition, such as an argon atmosphere or a nitrogen atmosphere. Furthermore, the steps f) and g) may be performed under the oxygen-free environment.

The step f) is the step of dissolving the oxidant in the solution C-1 and/or the solution C-2.

The oxidant may be any oxidant that has an ability of oxidizing the ligand. Examples of the oxidant may include, but are not limited to, ferrocenium salt and triarylammoniumyl salts.

The oxidant may be dissolved in the solution C-1 only, in the solution C-2 only, or in both solutions; preferably, the oxidant is dissolved in the solution C-2.

The step g) is the step of pouring the solution C-1 and the solution C-2 into the container so that the solutions are separated into two phases.

The specific gravities of the solution C-1 and the solution C-2 that are obtained may be different from each other, depending on the first solvent and the second solvent to be used, for example. The solution with relatively high specific gravity is poured into the container first, and after that, the solution with relatively low specific gravity is poured into the container, so that the solutions are separated into two phases.

The step g) may be performed for 1 hour to 20 days, preferably 1 to 15 days, more preferably 2 to 10 days, although the length of time depends on the ligand to be used and the concentration thereof, the compound of the metal M and the concentration thereof, or the structure of the two-dimensional metal complex to be obtained, such as the thickness.

The temperature of the step g) may be, depending on the ligand to be used and the concentration thereof, the compound of the metal M and the concentration thereof, or the structure of the two-dimensional metal complex to be obtained, such as the thickness, set to an arbitrary temperature in the range of the melting point of the solvent to the boiling point thereof.

The above steps can obtain the two-dimensional metal complex.

In the present method, similar to the method comprising the reaction at the gas-liquid interface or the electrochemical method, step (s) other than the above steps may be provided before the step a), between the steps, and/or after the step g).

For example, the step g) may be followed by a step of cleaning the obtained two-dimensional metal complex.

### <Solution for Manufacturing Two-Dimensional Metal Complex>

The present application provides a solution or a solution kit that is used for manufacturing the two-dimensional metal complex.

One example of the solution that is used for <<manufacturing method for two-dimensional metal complex—comprising reaction at gas-liquid interface>> and/or <<manufacturing method for two-dimensional metal complex—by electrochemical method>> described above is a solution comprising:

i) a ligand;

ii) a compound of a metal M, which is a raw material of a metal core M; and

iii) a solvent in which i) the ligand and ii) the compound are soluble,

wherein i) the ligand and ii) the compound are dissolved in the solution and the solution can be present in the oxygen-free environment. However, the solution is not limited to this example.

Here, the “ligand”, the “metal core M”, the “compound of the metal M, which is the raw material of the metal core M”, the “solvent in which the ligand and the compound are soluble”, and “oxygen-free” are defined as described above.

Furthermore, in a case where the solution in the reaction at the gas-liquid interface is used, the two-dimensional metal complex as described above can be obtained by bringing the solution into contact with the gas including oxygen. Before the solution is brought into contact with the gas including oxygen, the solution may be poured into the container that has a predetermined opening and that is appropriate for forming the two-dimensional metal complex in the oxygen-free environment, if necessary.

In a case where the solution in the electrochemical method is used, the aforementioned two-dimensional metal complex can be obtained by providing a device that carries out the electrochemical method described above, specifically, by providing predetermined anode and cathode and a predetermined current application device and carrying out the above method.

The present application provides the solution kit comprising two solutions as a solution used in <<manufacturing method for two-dimensional metal complex—comprising reaction at liquid-liquid interface>>.

The solution kit comprising the two solutions may comprise:

I) a first solution comprising A) a ligand and B) a first solvent that dissolves A) the ligand, wherein the I) first solution dissolves the A) ligand, and is present in the oxygen-free environment; and

II) a second solution comprising C) a compound of a metal M, which is a raw material of a metal core M, and D) a second solvent that dissolves C) the compound, wherein the II) second solution dissolves C) the compound, and is present in the oxygen-free environment.

Here, the “ligand”, the “first solvent”, the “first solution”, the “metal core M”, the “compound of the metal M, which is the raw material of the metal core M”, the“second solvent”, the“second solution”, and“oxygen-free” are defined as described above.

Furthermore, in a case where the solution kit in the reaction at the liquid-liquid interface is used, the two-dimensional metal complex as described above can be obtained by pouring the first solution and the second solution into the container in consideration of the specific gravity of the first and second solutions, so that the two solutions are separated into two phases, and causing the reaction at the interface of the two phases. The container to be used may be a container that has a predetermined opening and that is appropriate for forming the two-dimensional metal complex as necessary.

The present invention will be described in more detail with reference to Examples; however, the present invention is not limited to Examples below.

### EXAMPLES

### Example 1

### <A-1. Preparation of Two-Dimensional Metal Complex Whose Metal Core is Ni, Through Reaction at Gas-Liquid Interface>

Hexaaminobenzene trihydrochloride was obtained by a method according to the literature (Z.-G. Tao, X. Zhao, X. K. Jiang, Z.-T. Li. Tetra. Lett. 2012, 53, 1840). In a glove box under an argon atmosphere, a 1 mM aqueous solution of hexaaminobenzene trihydrochloride was prepared using degassed water and the hexaaminobenzene trihydrochloride.

Similarly, in a glove box under an argon atmosphere, a 0.05 M nickel acetate aqueous solution was obtained using degassed water, and an equivalent amount of condensed ammonia aqueous solution was added thereto, to obtain a dark blue aqueous solution.

Similarly, in a glove box under an argon atmosphere, 10 mL of the 1 mM aqueous solution of hexaaminobenzene trihydrochloride was added to a 50 mL vial. After that, to the resulting aqueous solution, 10 mL of the dark blue aqueous solution was added, and through diffusion, both solutions were mixed.

The vial containing the obtained mixed aqueous solution was closed tightly to shut out the external air, and then, the vial was taken out of the glove box to the air. The lid of the vial was gradually screwed open to allow a small gap between the lid and the vial, and then, the vial was left at rest. Oxygen in the air flowed in through the gap and diffused in argon in the vial, and then collided with an upper surface of the aqueous solution, where the oxidation progressed. Then, it was observed that a sheet substance was formed at the interface.

After 72 hours the lid of the vial was screwed open to allow the gap, the resulting sheet substance A1 was taken out and cleaned with pure water.

The sheet substance A1 had a thickness of 25 nm. The sheet substance A1 was subjected to various measurements such as powder X-ray diffraction (PXRD), X-ray photoelectron spectroscopy (XPS), an atomic force microscope (AFM), a scanning electron microscope (SEM), and a transmission electron microscope (TEM). As a result, it has been confirmed that the sheet substance A1 is the two-dimensional metal complex whose metal core is Ni and ligand is hexaaminobenzene. Specifically, it has been confirmed that the sheet substance A1 has the structure represented by the above formula C-1.

The conductivity and the redox potential were measured. The results show that the conductivity was 4×10⁻² Scm⁻¹ and the redox potential was 0.15 V vs. Ag⁺/Ag (0.83 V vs. SHE (standard hydrogen electrode)).

### Example 2

### <B-1. Preparation of Two-Dimensional Metal Complex Whose Metal Core is Ni, Through Electrochemical Synthesis>

The process according to the present example was performed entirely in the argon atmosphere.

Nickel acetate tetrahydrate (2.5 mg, 0.01 mmol), hexaaminobenzene (HAB) (2.5 mg, 0.015 mmol), and sodium tetrafluoroborate (NaBF₄) (0.11 g, 1 mmol) were dissolved in an ammonia aqueous solution (0.245 M), and the resulting solution was poured into a container that is used in an electrochemical synthesis method.

In the container containing the solution, the electrochemical synthesis was performed using ITO (or glassy carbon) as a working electrode, Pt with a coil shape as a counter electrode, and an Ag⁺/Ag electrode as a reference electrode. In the synthesis, automatic polarization system HZ-3000 (HOKUTO DENKO CORP.) was used.

Through chronocoulometry, constant voltage (−0.35 V) was applied for three minutes, so that a sheet substance B1 was formed on the working electrode.

When the constant voltage was set to 0.28 V, a sheet substance B2 was formed on the working electrode.

The obtained sheet substances B1 and B2 were observed using X-ray photoelectron spectroscopy (XPS), an atomic force microscope (AFM), and a scanning electron microscope (SEM), and the results were compared with those of Example 1. Then, it has been confirmed that the sheet substances B1 and B2 were the two-dimensional metal complex whose metal core is Ni and ligand is hexaaminobenzene. Specifically, it has been confirmed that the sheet substances B1 and B2 have the structure represented by the formula C-1. In addition, it has been confirmed that when the two-dimensional structure is one layer, the sheet substances B1 and B2 include more than one layer. Furthermore, it has been confirmed that the sheet substance B1 has a Ni/N ratio of 1:6, and the sheet substance B2 has a Ni/N ratio of 1:4.

The electrode including the obtained sheet substance B1 and the electrode including the sheet substance B2 were cleaned with ultrapure water and ethanol, and were subjected to the following electrocatalytic measurement (electrocatalytic measurement).

The redox potential was measured by a cyclic voltammetry (working electrode: electrode including sheet substance B1 and electrode including sheet substance B2; reference electrode: Ag⁺/Ag; counter electrode: platinum; 1.0 M tetrabutylammonium perchlorate/acetonitrile). As a result, the potential was 0.15 V vs. Ag⁺/Ag (0.83 V vs. SHE (standard hydrogen electrode)), which is similar to that of Example 1.

The conductivity of the sheet substance B1 and the sheet substance B2 was not measured. However, since the structure is similar to that of Example 1 and the redox potential obtained by the cyclic voltammetry is also equivalent to that of Example 1, it was suggested that the conductivity is equivalent to that of Example 1.

### <Electrocatalytic Measurement>

The electrocatalytic measurement was performed using the electrode including the sheet substance B1 as the working electrode, Pt with the coil shape as the counter electrode, and Ag/AgCl as the reference electrode.

The Ag/AgCl electrode was subjected to external measurement with respect to Fe (III)/Fe (II) (0.485V vs. Ag/AgCl) of ferrocene in an acetonitrile solution of 0.1 M tetrabutylammonium perchlorate. All the potentials in the hydrogen generating reaction were converted by adding (0.156+0.059×pH) V to the reversible hydrogen electrode (RHE). The potential in the oxygen generating reaction was converted by adding (−1.074+0.059×pH) V.

### <<Catalytic Hydrogen Generating Reaction>>

The catalytic hydrogen generating reaction was examined based on the linear scanning voltammetry at 0.05 M H₂SO₄ (pH=1), 1 M KCl (pH=7), and 0.1 M KOH (pH=13). To obtain the voltammogram, scanning was performed at a scan rate of 100 mV/s at +0.2 V to −1.2 V vs RHE.

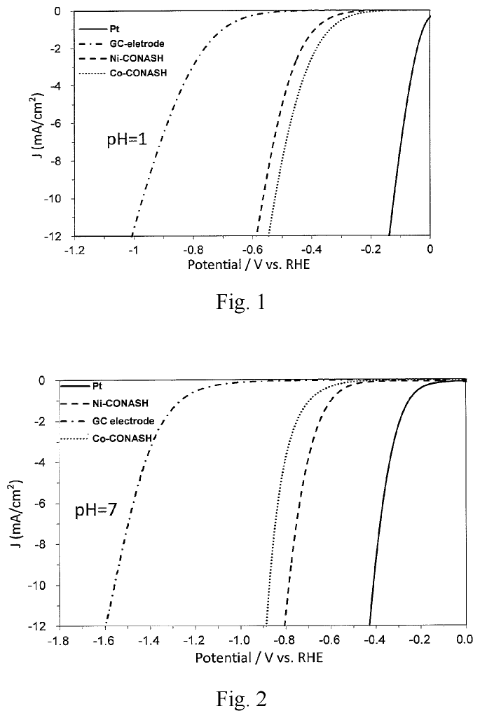

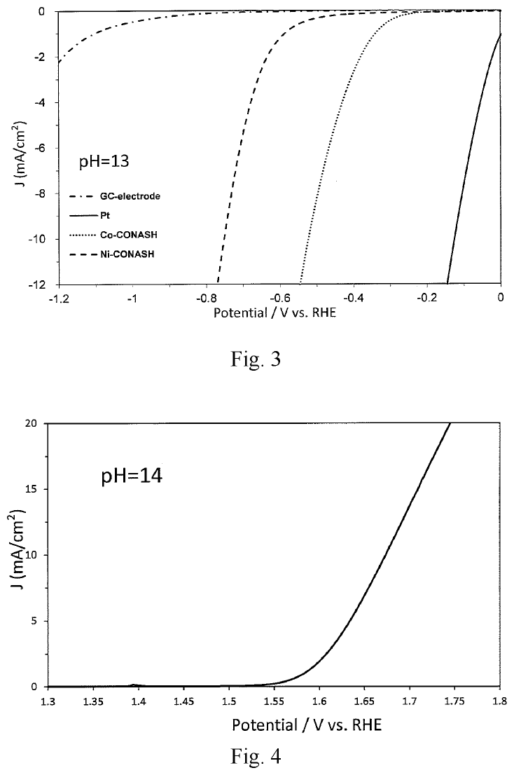

The results at 0.05 M H₂SO₄ (pH=1), 1 M KCl (pH=7), and 0.1 M KOH (pH=13) are shown in FIG. 1, FIG. 2, and FIG. 3, respectively.

FIG. 1 to FIG. 3 indicate that the graphs of the electrode including the sheet substance B1 (in FIG. 1 to FIG. 3, expressed as “Ni-CONASH”) are present between the graph of glassy carbon electrode (in FIG. 1 to FIG. 3, expressed to as “GC-elctrode”) and the graph of platinum (in FIG. 1 to FIG. 3, expressed as “Pt”). That is, the electrode including the sheet substance B1 has the catalytic ability to generate hydrogen.

### <<Catalytic Oxygen Generating Reaction>>

The catalytic oxygen generating reaction was examined based on the linear scanning voltammetry at 1 M KOH (pH=14). To obtain the voltammogram, scanning was performed at a scan rate of 1 mV/s at −0.1 V to +0.6 V.

The results are shown in FIG. 4. FIG. 4 indicates that the current flows in the electrode including the sheet substance B1 at an overpotential of about 0.3 V vs. RHE, and the current density is 10 mA/cm² at an overpotential of 1.67 vs. RHE. This value is approximately the same as the value of iridium oxide (IrO₂), which is 1.59V, and the value of ruthenium oxide (RuO₂), which is 1.64 V. Iridium oxide and ruthenium oxide are the electrode catalysts that are currently known to have the highest performance. Therefore, it is understood that the electrode including the sheet substance B1 has the catalytic ability to generate oxygen.

### <<Redox Capacitor Characteristic>>

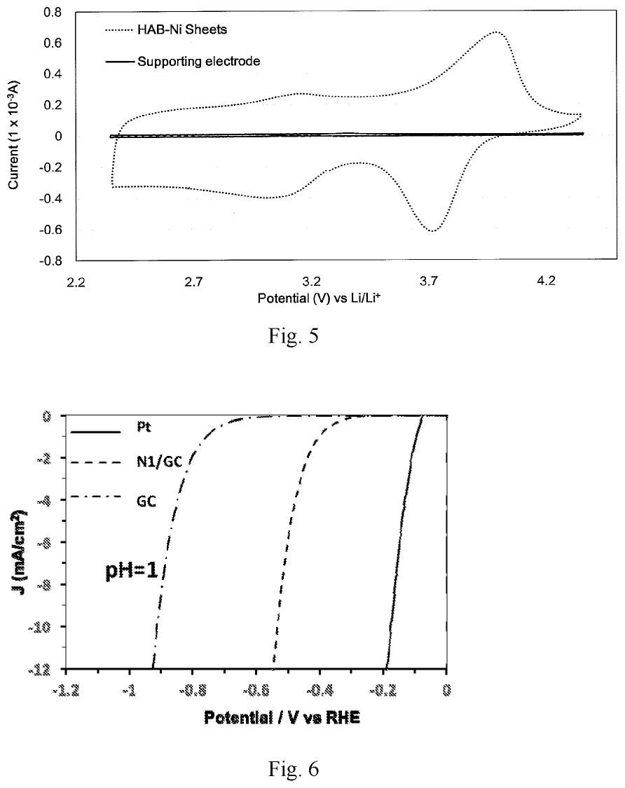

The redox capacitor characteristics was determined by cyclic voltammetry (working electrode: electrode including sheet substance B1 and electrode including sheet substance B2; reference electrode: Ag⁺/Ag; counter electrode: platinum; 1.0 M tetrabutylammonium perchlorate/acetonitrile). The results are shown in FIG. 5.

FIG. 5 indicates that the electrode including the sheet substance B1 (in FIG. 5, expressed as “HAB-Ni Sheets”) is in the range of 2.5 to 4.5 V vs. Li⁺/Li, and as compared to the electrode without the sheet substance B1 (in FIG. 5, expressed as “Supporting electrode”), a large current in which faradaic current and non-faradaic current are overlapped flows. The results indicate that the amount of charges per unit area is estimated to be 1.8×10⁻³ Ccm⁻². This value is 30 times the value of the electrode without B1, which is 5.1×10⁻⁵ Ccm⁻², and it is understood that the electrode including the sheet substance B1 is useful as the redox capacitor.

Because of having the above characteristics, the electrode comprising the sheet substance B1 is useful as the hydrogen generating catalyst, the oxygen generating catalyst, or the redox capacitor.

### Example 3

### <B-2. Preparation of Two-Dimensional Metal Complex Whose Metal Core is Co, Through Electrochemical Synthesis>

The process according to this example was performed entirely in the argon atmosphere.

Cobalt acetate.tetrahydrate (2 mg, 0.008 mmol) and ammonium tetrafluoroborate (NH₄BF₄) (104.84 mg, 1 mmol) were dissolved in 6.8 mL of ultrapure water, and to the resulting solution, a 1 M ammonia aqueous solution (3.2 mL) and HAB (1.5 mg, 0.01 mmol) were added and the obtained solution was poured into a container that is used in the electrochemical synthesis method.

By using the working electrode, the counter electrode, and the reference electrode that are the same as those in Example 2, constant voltage (−0.43 V) was applied for three minutes by chronocoulometry; thereby to form the sheet substance B3 on the working electrode. Furthermore, as a result of various measurements of the sheet substance B3, it has been confirmed that the sheet substance B3 has the structure represented by the formula C-1, which is similar to Example 1. If the two-dimensional structure is assumed to have one layer, it has been confirmed that the sheet substance B3 has more than one layer. Moreover, it has been understood that the Co/N ratio is 1:4.

The electrode including the obtained sheet substance B3 was cleaned with ultrapure water and ethanol, and was subjected to the following electrocatalytic measurement.

As a result of measuring the catalytic ability to generate hydrogen in a manner similar to Example 2, the graphs expressed as “Co-CONASH” in FIG. 1 to FIG. 3 were obtained. FIG. 1 to FIG. 3 indicate that the graph of the electrode including the sheet substance B3 (in FIG. 1 to FIG. 3, expressed as “Co-CONASH”) is present between the graph of glassy carbon electrode (in FIG. 1 to FIG. 3, expressed as “GC-elctrode”) and the graph of platinum (in FIG. 1 to FIG. 3, referred to as “Pt”). That is, the electrode including the sheet substance B3 has the catalytic ability to generate hydrogen.

Because of having the above characteristics, the electrode comprising the sheet substance B3 is useful as the hydrogen generating catalyst.

### Example 4

### <C-1. Preparation of Two-Dimensional Metal Complex Whose Metal Core is Ni, Through Reaction at Liquid-Liquid Interface>

The process according to the present example was performed entirely in the argon atmosphere.

A ligand aqueous solution (2.4×10⁻⁵ M) including the ligand represented by the following formula L-2, which contains ferrocenium tetrafluoroborate (FcBF₄) as the oxidant at 4.8×10⁻⁵ M and ammonia at 4.8×10⁻⁴ M, was prepared.

In addition to this ligand aqueous solution, a dichloromethane (CH₂Cl₂) solution (0.5 mM) of Ni (acac)₂ (acac means acetylacetonato, the same applies hereinafter) was prepared.

After adding 10 mL of the dichloromethane solution of Ni(acac)₂ to a glass vial with a diameter of 40 mm, 10 mL of the ligand aqueous solution was added, and thus, a solution that has a liquid-liquid interface, i.e., that is separated into two phases was prepared.

The solution with the two phases was left to stand for seven days; then, a brown sheet substance C1 was observed at the liquid-liquid interface.

The obtained sheet substance C1 was taken out and cleaned with water, ethanol, and dichloromethane; then, the substance was dried under vacuum at 120° C.

The sheet substance C1 has a thickness of 15 nm.

Furthermore, as a result of various measurements of the sheet substance C1 in a manner similar to Example 1, it has been confirmed that the sheet substance C1 is the two-dimensional metal complex whose metal core is Ni and ligand is represented by the formula L-2. Specifically, it has been confirmed that the sheet substance C1 has the structure represented by the following formula N1.

The conductivity and the redox potential were measured in a manner similar to Example 1. The results indicate that the conductivity was 1×10⁻¹ Scm⁻¹ and the redox potential was −0.1 V vs. Ag⁺/Ag (0.83 V vs. SHE (standard hydrogen electrode)) at a temperature of 298 K.

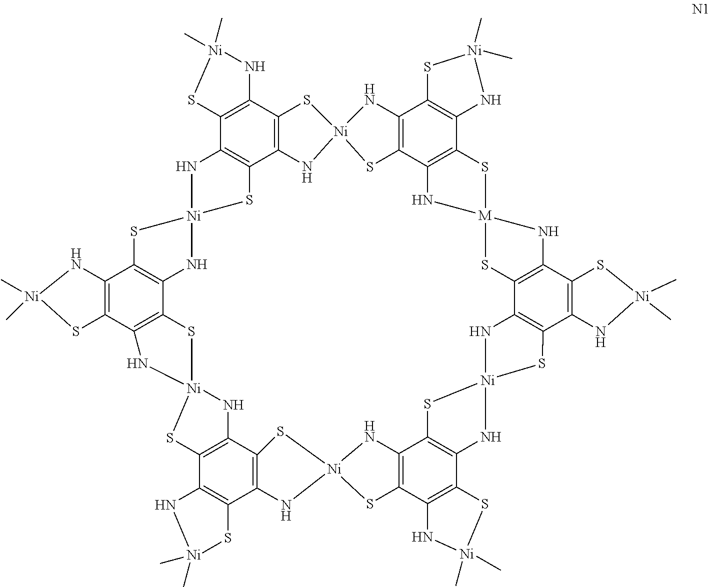

### Example 5

### <C-2. Preparation of Two-Dimensional Metal Complex Whose Metal Core is Ni, Through Reaction at Liquid-Liquid Interface>

A ligand aqueous solution containing the ligand (50 nM) represented by the formula L-2, 100 nM of ferrocenium tetrafluoroborate (FcBF₄) as the oxidant, and 1 μM of ammonia was prepared.

In addition to the ligand aqueous solution, a mixed solution of dichloromethane of Ni(acac)₂-ethyl acetate was prepared in a manner similar to Example 4, so that “0.5 mM” of Example 4 was changed into 0.1 mM.

The ligand aqueous solution was slowly dropped at room temperature to the solution of Ni(acac)₂ so that the solution had two phases; then, at the interface of the two phases, a sheet substance C2 was observed.

The obtained sheet substance C2 was moved to silicon or a HOPG substrate using Langmuir-Schaefer method, and then cleaned with water, ethanol, and dichloromethane. It has been confirmed that the sheet substance C2 has a thickness of 10 nm.

As a result of various measurements of the sheet substance C2 in a manner similar to Example 1, it has been confirmed that the sheet substance C2 is the two-dimensional metal complex whose metal core is Ni and ligand is represented by the formula L-2. Specifically, it has been confirmed that the sheet substance C2 has the structure represented by the formula N1 and the structure includes a stack of several layers.

### <<Electrocatalytic Measurement>>

The electrocatalytic measurement was performed using the electrode produced by applying 4 mL of ethanol containing 4 mg of the dispersed sheet substance C1 on the glassy carbon as the working electrode, Pt with the coil shape as the counter electrode, and Ag/AgCl as the reference electrode.

### <<Catalytic Hydrogen Generating Reaction>>

The catalytic hydrogen generating reaction was examined based on the linear scanning voltammetry in 0.05 M H₂SO₄ (pH=1). To obtain the voltammogram, scanning was performed at a scan rate of 100 mV/s at +0.2 V to −1.2 V vs RHE. The results are shown in FIG. 6.

FIG. 6 indicates that the graph of the electrode including the sheet substance C2 (in FIG. 6, expressed as “N1/GC”) is present between the graph of glassy carbon electrode (in FIG. 6, expressed as “GC”) and the graph of platinum (in FIG. 6, expressed as “Pt”). That is, the electrode including the sheet substance C2 has the catalytic ability to generate hydrogen.

1. A two-dimensional metal complex comprising:
a ligand having three or more positions for bidentate coordination, in which at least one of the bidentate coordination sites is NH; and
a metal core M, wherein M is at least one metal selected from the group consisting of Ni, Co, Cu, Pt, Pd, Fe, Mn, Re, Ru, Os, Rh, Ir, Ag, and Au;
wherein substantially all of the atoms of the ligand and the metal core, which substantially form the metal complex, are present on substantially the same plane.

2. The two-dimensional metal complex according to claim 1, wherein the ligand comprises an aryl group.

3. The two-dimensional metal complex according to claim 1,
wherein the ligand is represented by Ar(NH)ₙXₘ₋ₙ, wherein Ar represents an aryl group, X is at least one selected from the group consisting of S, O, Se and Te, m represents an integer of 6 or more, which is the number of bonding sites depending on the aryl group, and n represents an integer of 3 or more and m or less.

4. The two-dimensional metal complex according to claim 1, wherein the ligand is represented by Bz(NH)ₙX₆₋ₙ, wherein Bz represents a benzene ring, X is at least one selected from the group consisting of S, O, Se, and Te, and n represents an integer of 3 to 6.

5. The two-dimensional metal complex according to claim 1, wherein the ligand is derived from a compound represented by following formula L-1 or L-2:

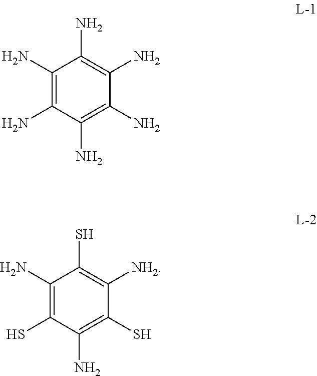 [SMILES: Nc1c(N)c(N)c(N)c(N)c1N ; Nc1c(S)c(N)c(S)c(N)c1S]

6. The two-dimensional metal complex according to claim 1, wherein the two-dimensional metal complex comprises three or more ligands.

7. The two-dimensional metal complex according to claim 1, wherein the two-dimensional metal complex comprises three or more metal cores.

8. The two-dimensional metal complex according to claim 1, wherein the two-dimensional metal complex comprises a site represented by following formula C-1, wherein each of M₁ to M₆ is independently at least one selected from the group consisting of Ni, Co, Cu, Pt, Pd, Fe, Mn, Re, Ru, Os, Rh, Ir, Ag, and Au, and each of Xₙ₁ to Xₙ₆ (n is 1 to 6) is independently a ligand atom or a ligand atom group represented by NH, S, O, Se, or Te:

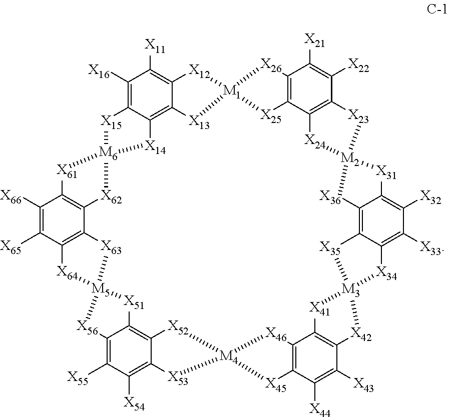

9. A two-dimensional metal complex comprising a site represented by following formula C-1, wherein each of M₁ to M₆ is independently at least one selected from the group consisting of Ni, Co, Cu, Pt, Pd, Fe, Mn, Re, Ru, Os, Rh, Ir, Ag, and Au, and each of Xₙ₁ to Xₙ₆ (n is 1 to 6) is independently a ligand atom or a ligand atom group represented by NH, S, O, Se, or Te:

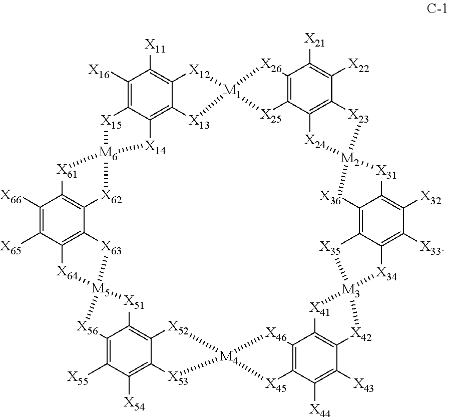

10. The two-dimensional metal complex according to claim 1, wherein the area of the plane formed by substantially all of the atoms of the ligand and the metal core, which substantially form the two-dimensional metal complex, is 7.2 mm² or more.

11. The two-dimensional metal complex according to claim 1, wherein the two-dimensional metal complex has a conductivity of 10⁻⁶ Scm⁻¹ or more.

12. The two-dimensional metal complex according to claim 1, wherein the two-dimensional metal complex has a redox potential in a range of −3 V to +3 V vs. SHE (standard hydrogen electrode).

13. The two-dimensional metal complex according to claim 1, wherein the two-dimensional metal complex has a porosity of 30% or more.

14. A material comprising the two-dimensional metal complex according to claim 1.

15. An element or a device comprising the material according to claim 14.

16. An element or a device comprising the two-dimensional metal complex according to claim 1.

17. A method for manufacturing the two-dimensional metal complex according to claim 1, comprising the steps of:
a) preparing a ligand;
b) preparing a compound of a metal M, which is a raw material of a metal core M;
c) dissolving the ligand that is prepared in the step a) and the compound of the metal M that is prepared in the step b) in a solvent in which the ligand and the compound are soluble, in an oxygen-free environment, to obtain a solution; and
d) bringing the solution that is obtained in the step c) in contact with gas including oxygen, thereby to form the two-dimensional metal complex at an interface of the solution.

18. A method for manufacturing the two-dimensional metal complex according to claim 1, comprising the steps of:
a) preparing a ligand;
b) preparing a compound of a metal M, which is a raw material of a metal core M;
c) dissolving the ligand that is prepared in the step a) and the compound of the metal M that is prepared in the step b) in a solvent in which the ligand and the compound are soluble in an oxygen-free environment, to obtain a solution; and
d) providing a positive electrode and a negative electrode in the solution that is obtained in the step c) and applying current between the positive electrode and the negative electrode, thereby to form the two-dimensional metal complex on a surface of the positive electrode.

19. The method according to claim 18, wherein the current is applied at a constant potential that is more positive than an oxidizing potential of the ligand in a range of −3 to 3 V vs. SHE.

20. An electrode comprising a two-dimensional metal complex obtained by the method according to claim 18.

21. A method for manufacturing the two-dimensional metal complex according to claim 1, comprising the steps of:
a) preparing a ligand;
b) preparing a compound of a metal M, which is a raw material of a metal core M;
c) dissolving the ligand that is prepared in the step a) in a first solvent in which the ligand is soluble, to obtain a first solution;
d) dissolving the compound of the metal M that is prepared in the step b) in a second solvent in which the compound is soluble, to obtain a second solution;
e) dissolving an oxidant in the first solution and/or the second solution; and
f) pouring the obtained first solution and the obtained second solution into a container so that the solutions are separated into two phases, thereby to form the two-dimensional metal complex at an interface of the two phases.

22. A solution for manufacturing the two-dimensional metal complex according to claim 1, comprising:
a ligand;
a compound of a metal M, which is a raw material of a metal core M; and
a solvent in which the ligand and the compound are soluble,
wherein the ligand and the compound are dissolved in the solution and the solution can be present in an oxygen-free environment.

23. A solution kit for manufacturing the two-dimensional metal complex according to claim 1, comprising:
a first solution including a ligand and a first solvent that dissolves the ligand, wherein the first solution dissolves the ligand, and is present in an oxygen-free environment; and
a second solution including a compound of a metal M, which is a raw material of a metal core M, and a second solvent that dissolves the compound, wherein the second solution dissolves the compound, and is present in the oxygen-free environment.
